(19) United States
(12) Patent Application Publication
(10) Pub. No.: US 2005/0086880 A1
(43) Pub. Date: Apr. 28, 2005

(54) Muntin clip

(76) Inventor: Allen D. Polowinczak, Monee, IL (US)

Correspondence Address: PAUL J. NYKAZA, ESQ.;WALLENSTEIN WAGNER & ROCKEY, LTD., 53RD FLOOR, 311 SOUTH WACKER DRIVE, CHICAGO, IL, 60606-6630, US

(21) Appl. No.: 10/694,266

(22) Filed: Oct. 27, 2003

(51) Int. Cl. E06B 3/964

(52) U.S. Cl. 52/204.62

(57) ABSTRACT

A muntin clip is provided for use with a sash window. The muntin clip is for use with a muntin grid located between panes of glass of a sash window separated by a pane separator. The muntin clip includes a base having a first surface frictionally engaging the separator and a connector extending from the base and adapted to engage the grid.

### TECHNICAL FIELD

This invention relates generally to muntin grids for sash window assemblies and more specifically to a textured muntin clip for positioning the grid within a sash window assembly.

### BACKGROUND OF THE INVENTION

Double hung window assemblies typically include a pair of sash windows slidably mounted within a master frame. In the past, sash windows were provided with a grid of muntin bars, typically made of wood, that separated and held multiple panes of glass within a sash. Each pane would be mounted within the sash in the same plane. Now, double or multiple pane windows are provided, otherwise known as insulated or thermo-pane window assemblies. These insulated sash windows include a pair of glass panes mounted in parallel to one another within a sash frame and separated by a small distance. Of course, insulated or thermo pane windows are not limited to single or double hung window arrangements. Rather, they have a wide range of applications that are well known in the art. For instance, double pane windows may be incorporated in doors, picture windows, etc.

Grids formed by interconnected muntin bars are often installed between these glass panes of a double pane or insulated sash window. Such an arrangement can generally be seen in FIG. 1. Typically these grids are comprised of multiple muntin bars arranged in a grid pattern and interconnected at interior intersecting points by muntin joiners. The grid is then placed between the panes of glass. The periphery of the grid is then mounted to the sash frame by a series of muntin clips. It is understood that the grid can take a variety of different forms.

Typically, the muntin bars are of a tubular or hollow construction and a portion of the clip is received by an end of a muntin bar located at a periphery of the grid. The clip, in turn, seats against an interior surface of the sash frame located within or between the panes.

One of the drawbacks of previous muntin clips is that they tend to allow relative movement between the clip and sash frame. This allows relative movement between any one of the muntin bar ends and the sash frame. Such muntin grid movement, no matter how slight, can result in an undesirable aesthetic appearance. Furthermore, more substantial muntin grid movement can cause the interconnection between muntin bars of the grid to become loose or to break, potentially resulting in the grid falling apart within the panes of glass. Such muntin grid movement can also result in other damage to the sash window and result in other undesirable consequences.

A prior art clip 136 is shown in FIG. 7. As discussed above, the prior art clip 136 is configured such that it may permit more relative movement between the clip 136 and the sash frame.

The present invention is provided to solve these and other problems.

### SUMMARY OF THE INVENTION

A muntin clip is provided for use with a sash window. The muntin clip is for use with a muntin grid located between panes of glass of a sash window separated by a pane separator. The muntin clip includes a base having a first surface frictionally engaging the separator and a connector extending from the base and adapted to engage the grid.

According to another aspect of the invention, the first surface is located on a lip extending from the base.

According to another aspect of the invention, the first surface is textured.

According to another aspect of the invention, the first surface comprises a protrusion.

According to another aspect of the invention, the first surface comprises a plurality of protrusions.

According to another aspect of the invention, the first surface includes an adhesive applied thereto.

According to another aspect of the invention, the lip extends from the base in a direction generally opposite to the direction from which the connector extends from the base.

According to another aspect of the invention, the connector extends from the base from a second surface wherein the first surface is opposite from the second surface.

According to another aspect of the invention, the connector comprises a leg.

Other features and advantages of the invention will be apparent from the following specification taken in conjunction with the following drawings.

### BRIEF DESCRIPTION OF THE DRAWINGS

FIG. 1 is a perspective view of a window assembly;

FIG. 2 is a cross sectional view of a muntin clip of the present invention installed within a sash window of the window assembly of FIG. 1;

FIG. 3 is a perspective view of the muntin clip of FIG. 2;

FIG. 4 is a side elevation view of the muntin clip of FIG. 2;

FIG. 5 is a front elevation view of the muntin clip of FIG. 2;

FIG. 6 is a top view of the muntin clip of FIG. 2; and

FIG. 7 is perspective view of a prior art muntin clip.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

FIG. 1 shows a sash window 12 comprised of a top sash rail 16, a base sash rail 18 and a pair of vertical stiles 20. Although not shown, the sash window 12 may be mounted, slidingly or otherwise, within a master frame, such as, in a single or double hung window arrangement as is well known in the art.

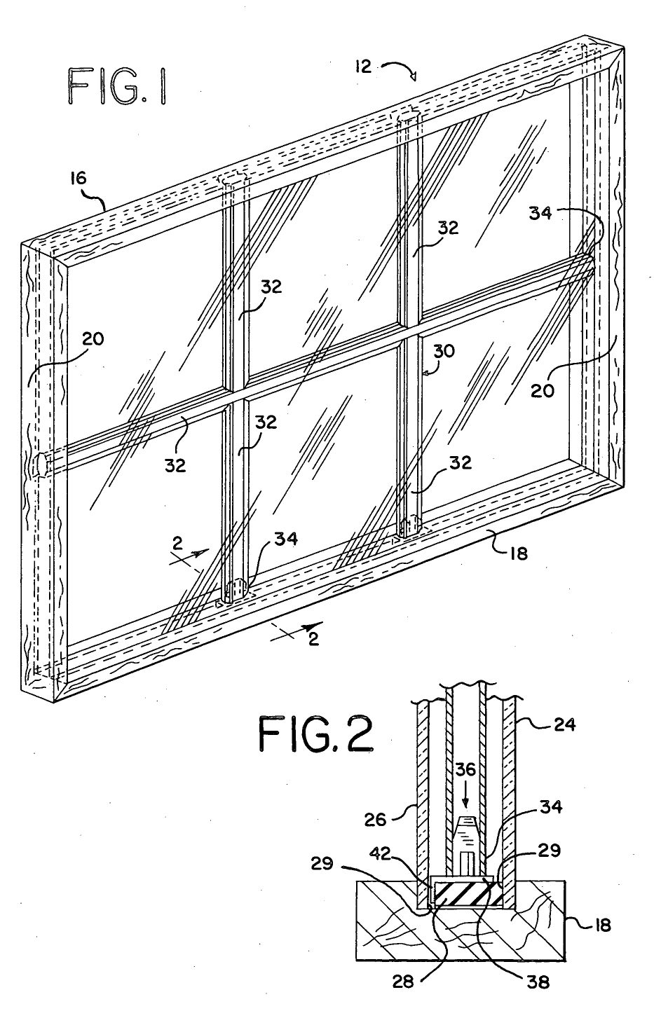

As shown in FIG. 2, each sash window 12 also includes a first pane of glass 24 and a second pane of glass 26 mounted in parallel relationship to one another within an interior of the sash window 12. The first and second panes 24, 26 are spaced by a pane separator 28 located at a periphery of the panes 24, 26. Each pane 24, 26 abuts against and confronts an edge 29 of the separator 28. Positioned between the first and second panes 24, 26 is a muntin grid 30.

The muntin grid 30 is comprised of a plurality of interconnecting muntin bars 32. Each muntin bar 32 has a generally tubular and hollow construction. Various means of inter-connecting the muntin bars 32 are known to those skilled in the art. The connecting means are not further described herein and any means of connecting the muntin bars 32 to one another may be utilized. As can be seen from the figures, the muntin bars 32 are so interconnected to form a grid 30 which is positioned between the first and second panes of glass 24, 26. Extending towards and located at a periphery of the grid 30 are a plurality of muntin bar ends 34. It is understood that the grid 30 can take a variety of forms.

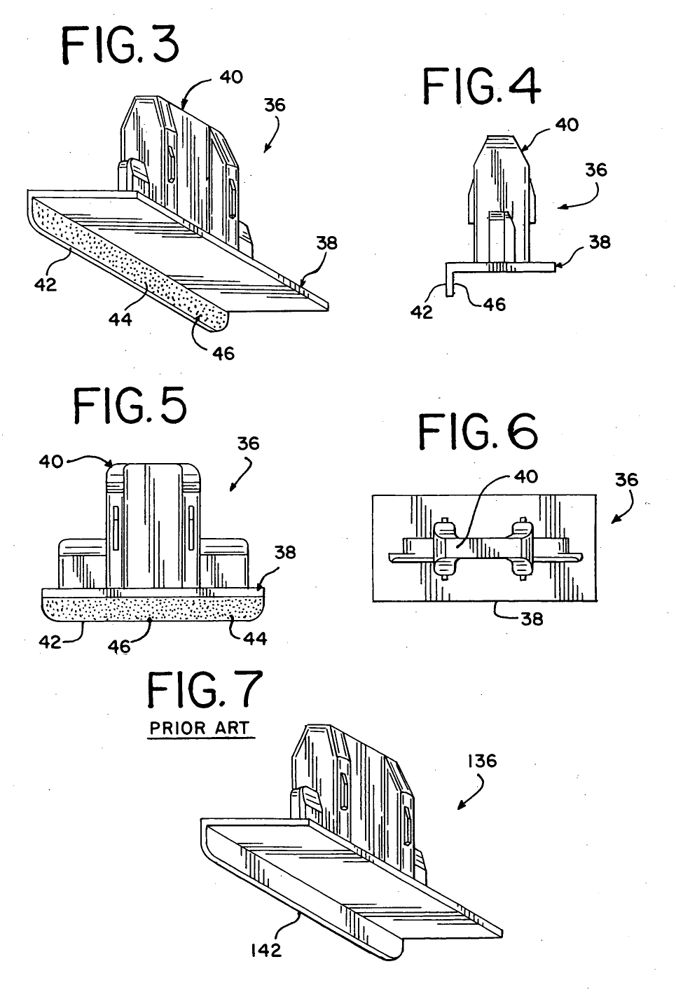

As shown in FIGS. 2-6, a muntin clip 36 mounts each muntin bar end 34 to the sash window 12, to be explained. Each muntin clip 36 includes a base 38, and a leg or attachment member or connector 40. The base 38 is generally rectangular and configured to fit between the first and second panes 24, 26 of glass as generally shown in FIG. 2. Extending from the base 38 in a first direction is a lip 42. Projecting from the lip 42 is a series of protrusions 44 defining a textured surface 46.

The leg 40 extends from the base in a second direction. The leg 40 is adapted to be received by and frictionally engage a muntin bar end 34.

In use, the muntin bars 32 are interconnected to form a grid 32 substantially as shown in FIG. 1. A muntin clip 36 is inserted into each muntin bar end 34 such that the leg 40 of each clip 36 is received by and frictionally engages an interior of a respective muntin bar end 34. The grid 32 with the installed muntin clips 36 is placed between the first and second panes 24, 26 of glass such that each muntin clip 36 is positioned generally as shown in FIG. 2.

Alternatively, the muntin clip 36 could be connected to the muntin bar ends 34 by other means. For instance, the leg 40 could be configured to be attached to the grid 30 via an adhesive or by use of a fastener such as a screw or rivet.

As shown, the base 38 of the clip 36 is positioned between the panes 24, 26 and rests against or confronts the pane separator 28. The lip 42 is positioned, or sandwiched, between the second pane of glass 26 and an edge 29 of the separator 28. The textured surface 46 of the lip 42 faces the edge 29 of the separator 28 and is pressed against the separator edge 29 by the second pane 26. In turn, this presses the protrusions 44 into the separator edge 29 thereby causing the textured surface 46 to frictionally engage the separator 28. This frictional engagement reduces or eliminates any relative movement of the clips 36 with respect to the separator 28.

It is understood that the textured surface 46 could be comprised of protrusions 44 of any shape and/or arrangement so long as the protrusions 44 or texturing has the effect of increasing the friction between the lip 42 and the separator 28 when in an assembled state, as compared to having no protrusions 44 or texturing. Additionally, any other means of increasing the coefficient of friction between the lip 42 and the separator edge 29 could be utilized. For instance, an adhesive or tacky substance could be applied to the lip 42 to accomplish this end. Typically, the clip 36 is made of material of sufficient strength such as nylon. Additionally, a two-shot molding process could be used to manufacture the clip 36 resulting in the lip 42 being comprised of a softer, or more tactile material than that of the rest of the clip 36. This would also tend to increase the coefficient of friction of between the lip 42 and the separator 28.

While the specific embodiments and various details thereof have been illustrated and described, numerous modification come to mind without significantly departing from the spirit of the invention and the scope of protection is only limited by the following claims.

1. A muntin clip for use with a muntin grid between panes of glass of a sash window separated by a pane separator, the muntin clip comprising:
a base having a first surface adapted to frictionally engage the separator; and
a connector extending from the base and adapted to engage the grid.

2. The muntin clip of claim 1 wherein the first surface is located on a lip extending from the base.

3. The muntin clip of claim 1 wherein the first surface is textured.

4. The muntin clip of claim 1 wherein the first surface comprises a protrusion.

5. The muntin clip of claim 1 wherein the first surface comprises a plurality of protrusions.

6. The muntin clip of claim 1 wherein the first surface includes an adhesive applied thereto.

7. The muntin clip of claim 2 wherein the lip extends from the base in a direction generally opposite to the direction from which the connector extends from the base.

8. The muntin clip of claim 1 wherein the connector extends from the base from a second surface wherein the first surface is opposite from the second surface.

9. The muntin clip of claim 1 wherein the connector comprises a leg.

10. A muntin clip for use with a muntin grid between panes of glass of a sash window separated by a pane separator, the muntin clip comprising:
a base having a textured surface adapted to frictionally engage the separator; and
a leg extending from the base and adapted to engage the grid.

11. A sash window comprising:
a first pane of glass and a second pane of glass spaced from the first pane of glass by a pane separator;
a muntin grid located between the first pane and second pane including a muntin bar; and
a muntin clip having a base having a first surface frictionally engaging the separator and a leg extending from the base and adapted to engage the muntin bar.

12. The muntin clip of claim 11 wherein the first surface is located on a lip extending from the base.

13. The muntin clip of claim 11 wherein the first surface is textured.

14. The muntin clip of claim 11 wherein the first surface comprises a protrusion.

15. The muntin clip of claim 11 wherein the first surface comprises a plurality of protrusions.

16. The muntin clip of claim 12 wherein the lip extends from the base in a direction generally opposite to the direction from which the leg extends from the base.

17. The muntin clip of claim 11 wherein the leg extends from the base from a second surface wherein the first surface is opposite from the second surface.

18. A window assembly comprising:
a master frame;
a sash window mounted in the master frame and having a pair of window panes spaced by a pane separator;
a muntin grid located between the window panes having a muntin bar; and
a muntin clip having a base with a first surface frictionally engaging the pane spacer and a leg extending from the base received by the muntin bar.

19. The window assembly of claim 18 wherein the first surface is located on a lip extending from the base.

20. The window assembly of claim 18 wherein the first surface is textured.

21. The window assembly of claim 18 wherein the first surface comprises a protrusion.

22. The window assembly of claim 18 wherein the first surface comprises a plurality of protrusions.

23. The window assembly of claim 19 wherein the lip extends from the base in a direction generally opposite to the direction from which the leg extends from the base.

24. The window assembly of claim 18 wherein the leg extends from the base from a second surface wherein the first surface is opposite from the second surface.

25. A muntin grid for use with a multi-pane insulted window sash having at least a pair of window panes being separated by a pane separator, the grid comprising:
a plurality of interconnected muntin bars, at least one muntin bar having a muntin bar end;
a muntin clip comprising a base having a first surface adapted to frictionally engage the separator and a connector extending from the base and attached to the muntin bar end.

26. The muntin grid of claim 25 wherein the first surface is located on a lip extending from the base.

27. The muntin grid of claim 25 wherein the first surface is textured.

28. The muntin grid of claim 25 wherein the first surface comprises a protrusion.

29. The muntin grid of claim 25 wherein the first surface comprises a plurality of protrusions.

30. The muntin grid of claim 26 wherein the lip extends from the base in a direction generally opposite to the direction from which the connector extends from the base.

31. The muntin grid of claim 25 wherein the connector extends from the base from a second surface wherein the first surface is opposite from the second surface.

32. The muntin grid of claim 25 wherein the connector comprises a leg.

33. A muntin clip for use with a muntin grid between panes of glass of a sash window separated by a pane separator, the muntin clip comprising:
a base having means adapted for frictionally engaging the separator; and
a connector extending from the base and adapted to engage the grid.

34. The muntin clip of claim 33 wherein the means for frictionally engaging is located on a lip extending from the base.

35. The muntin clip of claim 33 wherein the means for frictionally engaging comprises a textured surface.

36. The muntin clip of claim 35 wherein the textured surface comprises a protrusion.

37. The muntin clip of claim 35 wherein the textured surface comprises a plurality of protrusions.

38. The muntin clip of claim 33 wherein the means for frictionally engaging comprises an adhesive substance.

39. The muntin clip of claim 34 wherein the lip extends from the base in a direction generally opposite to the direction from which the connector extends from the base.

40. The muntin clip of claim 33 wherein the connector comprises a leg.
